(19) United States
(12) Patent Application Publication
(10) Pub. No.: US 2025/0177902 A1
(43) Pub. Date: Jun. 5, 2025

(54) CARBON CAPTURE SYSTEM

(71) Applicants: TOTALENERGIES ONETECH, Courbevoie (FR); POLITECNICO DI MILANO, Milano (IT); UNIVERSITEIT UTRECHT HOLDING B.V., Utrecht (NL)

(72) Inventors: Luis Manuel Cravo Pereira, Santiago do Cacém (PT); Maxime Lacroix, Sainte-Adresse (FR); Matteo Gazzani, Utrecht (NL); Matteo Carmelo Romano, Piacenza (IT); Federico d'Amore, Padova (IT); Stefano Campanari, Lecco (IT)

(21) Appl. No.: 18/832,122

(22) PCT Filed: Jan. 23, 2023
(86) PCT No.: PCT/EP2023/051521

§ 371 Date: Jul. 23, 2024

(30) Foreign Application Priority Data
Jan. 25, 2022 (EP) 22153148.6

(51) Int. Cl. B01D 53/047; B01D 53/00; C01B 3/12; C01B 3/34; C01B 3/56; H01M 8/0612; H01M 8/0668; H01M 8/14; H01M 8/18

(52) U.S. Cl. CPC B01D 53/0476; B01D 53/002; C01B 3/12; C01B 3/34; C01B 3/56; H01M 8/0618; H01M 8/0668; H01M 8/186; B01D 2253/102; B01D 2253/108; B01D 2256/16; B01D 2257/504; C01B 2203/0233; C01B 2203/0283; C01B 2203/042; H01M 2008/147

(57) ABSTRACT

A carbon capture system may include a pressure swing adsorption unit for producing a product gas and a tail gas comprising at least one carbonaceous gas. The carbon capture system may include a molten carbonate fuel cell having a cathode and an anode for transferring CO₂ from the cathode to the anode. The molten carbonate fuel cell may be a multi-stage fuel cell where the anode is in fluid communication with the pressure swing adsorption unit for receiving at least a portion of the tail gas as an inlet stream.

### CROSS REFERENCE TO RELATED APPLICATIONS

The present application is a national stage entry according to 35 U.S.C. § 371 of PCT application No.: PCT/EP2023/051521 filed on Jan. 23, 2023; which claims priority to EP Patent Application Serial No.: 22153148.6, which was filed on Jan. 25, 2022; which are incorporated herein by reference in their entirety and for all purposes.

### TECHNICAL FIELD

The invention relates to carbon capture systems, and further relates to corresponding methods and uses, wherein carbon capture is in particular carbon dioxide (CO₂) capture. The carbon capture system and the corresponding methods and uses are in particular useful in the context of hydrogen production.

### BACKGROUND

According to the International Energy Agency (IEA), the global demand for hydrogen (H₂) and H₂-derived fuels will significantly increase in the coming years. This is inter alia because H₂ is expected to play a key role in mitigating global warming. However, the production of H₂ often results in the undesired generation and potential emission of the greenhouse gas CO₂. For example, in the so-called partial oxidation (POX), natural gas which predominantly comprises methane (CH₄) as well as other hydrocarbons is reacted with a limited amount of oxygen (O₂). The limited amount of O₂ is a less than stoichiometric amount. Accordingly, this limited amount of O₂ is not sufficient to completely oxidize the methane and other hydrocarbons to CO₂ and water (H₂O). The reaction products are thus primarily H₂ and carbon monoxide (CO). Regularly, in order to increase the H₂ yield, the CO is reacted in a subsequent water-gas shift (WGS) reaction with H₂O to form CO₂ and more H₂, basically following the reaction CO+H₂O→CO₂+H₂. Thereby, mixtures comprising H₂ and CO₂ are generated.

Similarly, CO₂ is also generated in so-called steam methane reforming (SMR) which involves the reaction of CH₄ with steam (H₂O_{(g)}) at high pressures and temperatures. The reaction yields a mixture containing predominately H₂ and CO, which mixture is also sometimes referred to as syngas. WGS reactors are typically used downstream the SMR to convert the produced CO and additional H₂O into more H₂ and CO₂, thereby increasing the overall H₂ yield. However, again gas mixtures comprising H₂ and CO₂ are generated.

Additionally, heat for the endothermic SMR is regularly generated by combusting fuel gas with air in the SMR furnace, thereby contributing to the production of more CO₂. The CO₂ contained in the flue gas is regularly diluted in nitrogen (N₂) and oxygen (O₂) from the combustion air.

Another process for producing H₂ is the so-called auto-thermal reforming (ATR). ATR basically combines POX and SMR, using the heat from the generally exothermic POX to provide heat for the generally endothermic SMR. Usually, a mixture of H₂ and CO is produced, for example according to the reaction 4 CH₄+O₂+2 H₂O→10 H₂+4 CO. Regularly, for increasing the H₂ yield, also in ATR the produced CO is subsequently converted in a WGS reaction with additional H₂O to CO₂ and H₂, leading once again to a gas mixture comprising CO₂ and H₂.

The above methods for producing H₂ have thus in common that in addition to the desired H₂, also typically large amounts of CO₂ are produced which are regularly admixed with H₂. In other words, the produced H₂ is contaminated with CO₂. In order to purify the H₂ for subsequent use thereof, it is desirable to separate the CO₂ from the H₂. Such a separation also allows to subsequently store the CO₂, thus avoiding an emission of that CO₂ to the environment.

Current methods for capturing CO₂ from gas mixtures like H₂/CO₂ and N₂/CO₂ use for example amine absorption stripper systems. Such systems have however a high heat demand for regeneration of the amine solvent. Additionally, amines easily undergo thermal- and oxidative-degradation, thereby forming hazardous compounds like nitrosamines, nitramines, and amides, which compounds already at very low concentrations are toxic and carcinogenic for humans.

Another way of separating CO₂ from a mixture of gases is to use a pressure swing adsorption (PSA) unit. As further detailed below, PSA is generally a process that separates single gases from a gas mixture. The use of a PSA in an SMR process is for example described in WO 2020/131981 A1. The PSA unit generates a purified H₂ stream and a tail gas, wherein the tail gas is used as fuel in the SMR reactor.

In general, a further way of separating CO₂ from a mixture of gases is to use a molten carbonate fuel cell (MCFC) for increasing the CO₂ concentration in a flue gas. For example, US 2005/0271914 A1 describes a power plant system for processing fossil fuel which is arranged in tandem with an MCFC. The flue gas of the power plant serves exclusively as the inlet gas for the cathode section of the MCFC. No reference to a PSA unit is made, and consequently no relationship of such a PSA unit with other components of the described power plant systems is described. US 2014/260310 A1 describes systems and methods for integrated operation of a molten carbonate fuel cell with turbines for power generation. However, a connection between an outlet of a PSA and a molten carbonate fuel cell is not addressed therein.

A combined use of a PSA unit and a molten carbonate fuel cell is generally described in WO 2017/190066 A1. However, there is no mention of any connection between the PSA unit and the fuel cell. Moreover, the fuel cell is operated in reverse, i.e., in electrolysis mode, in which electric energy is consumed by the fuel cell. For this operation in reverse, the anode of the fuel cell is actually configured to receive a reformed gas from a steam methane reformer. A similar arrangement is described by A. Monforti Ferrario et al. (Front. Energy Res. 9:655915) in which a PSA unit is connected with a molten carbonate fuel cell which also runs in reverse. That is, the respective fuel cell is actually a molten carbonate electrolysis cell (MCEC) which consumes electric energy. In the described arrangement, PSA tail gas is sent to the anode of the MCEC. A combined use of a PSA unit and a molten carbonate fuel cell running in electricity production mode is described by S. Consonni et al. (Advances in Applied Energy 2 (2021) 100010). The described process intends to capture CO₂ from SMR flue gas. However, it is mandatory for the described process that PSA tail gas is sent to the cathode of the MCFC employed, and the overall energy efficiency of the SMR still drops compared to the process without CO₂ capture. WO 2021/181249 A1 also generally describes a combined use of a PSA unit and a molten carbonate fuel cell. However, the molten carbonate fuel cell is a single-stage fuel cell, and gas fed to its anode is regularly pre-treated by compressing, chilling and separating CO₂ which adds to the complexity and the costs of the described systems.

Overall, there remains a general desire for an improved carbon capture system, in particular in the context of hydrogen production.

### SUMMARY

It is an object of the present invention to provide a carbon capture system which at least partially overcomes the drawbacks encountered in the art.

It is in particular an object of the present invention to provide a carbon capture system which allows to efficiently capture CO₂, in particular CO₂ generated in a hydrogen production.

It is furthermore an object of the present invention to provide a carbon capture system which, when used in the context of hydrogen production, allows to provide H₂ of improved purity.

It is moreover an object of the present invention to provide a carbon capture system which simultaneously allows both, CO₂ capture and production of electric energy (electricity), preferably followed by an advantageous use of the produced electric energy. In this regard, it is also an object of the present invention to provide a carbon capture system which is at least partially self-supporting.

It is also an object of the present invention to provide a method of capturing carbon which at least partially overcomes the drawbacks encountered in the art.

It is also an object of the present invention to provide uses which at least partially overcome the drawbacks encountered in the art.

It is also an object of the present invention to provide CO₂ which at least partially overcomes the drawbacks encountered in the art.

### DETAILED DISCLOSURE

Surprisingly, it has been found that the problem underlying the invention is overcome by carbon capture systems, methods, uses, and CO₂ according to the claims. Further embodiments of the invention are outlined throughout the description.

Subject of the invention is a carbon capture system, comprising:
a pressure swing adsorption unit for producing a product gas and a tail gas comprising at least one carbonaceous gas, and
a molten carbonate fuel cell having a cathode and an anode for transferring CO₂ from the cathode to the anode, wherein the molten carbonate fuel cell is a multi-stage fuel cell,
wherein the anode is in fluid communication with the pressure swing adsorption unit for receiving at least a portion of the tail gas as an inlet stream.

A carbon capture system according to the present invention captures carbon in particular in the form of CO₂ and may thus also be termed a CO₂ capture system. More specifically, the molten carbonate fuel cell transfers (or pumps) CO₂ from the cathode to the anode. For this, the cathode is regularly to be fed with a CO₂-containing gas. For example, while the anode receives a first portion of the tail gas as an inlet stream, the cathode may receive a second portion of the tail gas as an inlet stream (cathode inlet stream). For this, the cathode would be in fluid communication with the pressure swing adsorption unit. The second portion of the tail gas sent to the cathode may optionally be mixed with additional air. For this, the fluid communication between the cathode and the pressure swing adsorption unit would have an inlet or a switch for feeding the additional air. Alternatively, or additionally, a CO₂-containing gas sent to the cathode may be flue gas stemming from an auxiliary gas boiler, a furnace, a gas turbine, and/or a steam methane reformer. For this, the cathode would be in fluid communication with the auxiliary gas boiler, the furnace, the gas turbine, and/or the steam methane reformer. The flue gas sent to the cathode may optionally be mixed with additional air. For this, the fluid communication between the cathode and the auxiliary gas boiler, the furnace, the gas turbine, and/or the steam methane reformer would have an inlet or a switch for feeding the additional air.

A pressure swing adsorption (PSA) unit according to the present invention is a unit which allows to perform at least one and preferably more than one (i.e., repeated) cycle(s) of PSA. The PSA unit thus regularly comprises at least two columns which typically contain an absorbent, and regularly comprises more than two columns, especially four to twelve columns. Further, the at least two columns can be individually, and normally alternatingly, fed with fluids and in particular gases. Further, such fluids and in particular gases can individually, and normally alternatingly, be withdrawn from the PSA unit. The PSA unit may further comprise a compressor to feed the at least two columns individually, and normally alternatingly, with pressurized gases. A pressure swing adsorption unit according to the present invention also encompasses a vacuum pressure swing adsorption (VPSA) unit, which further comprises a vacuum pump for generating a vacuum inside the PSA unit to withdraw gases contained in the PSA unit, in particular gases adsorbed by an absorbent. It is preferred that in a PSA unit according to the present invention, absorbents comprising carbon, in particular activated carbon or carbon molecular sieves, or oxide absorbents, in particular zeolites, are contained.

The PSA is generally a process that separates single gases from a gas mixture. According to the present invention, the PSA is preferably used to separate H₂ from a gas mixture, in particular a CO₂-containing gas mixture, so as to purify the H₂. The PSA applies the principle of physically binding impurities contained in the hydrogen, especially CO₂, by an individually selected absorbent. Since the binding forces for such impurities, especially CO₂, depend on the pressure, the PSA operates on an alternating cycle of adsorption at elevated pressures and desorption at decreased pressures. Ideally, only the gas to be separated, preferably CO₂, is adsorbed, while all other gases in the mixture, preferably including H₂, pass through the absorbent.

It is preferred that a PSA process occurring in a PSA unit according to the present invention is divided into four stages that preferably occur in repeated cycles:
Adsorption: adsorption takes place at a high pressure, preferably an absolute pressure above 0.1 MPa and up to 4 MPa. A feed gas mixture, preferably a mixture comprising CO₂ and H₂, is fed to an absorbent. The absorbent binds the more easily absorbable gas molecules, preferably CO₂ molecules, while gas molecules that are not readily absorbable or not absorbable at all, preferably H₂ molecules, pass through the absorbent (or absorbent bed). The absorbent continues to absorb gas molecules until it reaches its full capacity.
Depressurization: depressurization is a first regeneration (or desorption) step of the absorbent carrying the absorbed gas molecules, preferably CO₂ molecules. As the pressure drops, the gas molecules in the absorbent, preferably CO₂ molecules, are released and are discharged from a section of the PSA unit in which the absorbent is located, typically one or more columns (or vessels, or containers) loaded with the absorbent.
Purging: the absorbent is purged with gas, preferably with H₂, to regenerate it.
Re-pressurization: the PSA unit is pressurized again, preferably using the feed gas mixture, until the process conditions for adsorption have been restored.

A molten carbonate fuel cell (MCFC) according to the present invention comprises a cathode and an anode as fuel cell electrodes. It is noteworthy here that because the MCFC is a multi-stage MCFC, the overall cathode of the MCFC is composed of two or more separate cathode portions in series, and the overall anode of the MCFC is composed of two or more separate anode portions in series. These electrodes (or electrode portions) are typically made of metal, in particular nickel. Between the electrodes, the MCFC regularly further comprises an electrolyte which comprises at least one carbonate. It is noteworthy here that because the MCFC is a multi-stage MCFC, the overall electrolyte of the MCFC is composed of two or more separate electrolyte portions sandwiched between the two or more cathode portions in series and the two or more separate anode portions in series. The electrolyte preferably comprises a blend of alkali metal carbonates, more preferably a blend of lithium carbonate (Li₂CO₃) and potassium carbonate (K₂CO₃). An MCFC is suitable for distributed power generation with high efficiency conversion of energy, flexible operation and combined heat and power (CHP) production. MCFCs are already commercially available in medium- to large scale power generation (see for example I. Rexed, “Applications for Molten Carbonate Fuel Cells”, PhD thesis, 2014, KTH Royal Institute of Technology, Stockholm, Sweden).

At ambient temperature (e.g., around 25° C.), the carbonate(s) in the MCFC is/are solid. The MCFC is regularly operated at temperatures above ambient, typically within a preferred temperature range of 540 to 750° C., more preferably in the range of 550 to 700° C., and still more preferably in the range of 575° C. to 675° C. At such temperatures, the contained carbonate(s) is/are molten, leading to the term “molten carbonate fuel cell”. The MCFC produces electric energy (generates electricity).

The electric energy produced by the MCFC can be advantageously used within the carbon capture system itself for at least partially operating one or more devices (PSA, means, units, etc.) of the carbon capture system, as further exemplified herein. The electric energy is generally produced by the MCFC according to the following scheme: O₂ and CO₂, which are regularly contained in combustion gases or that may be added separately, are reduced at the cathode into carbonate ions (CO₃²⁻) following the reaction:

½O₂+CO₂+2e−=CO₃²⁻

The carbonate ions CO₃²⁻ are transferred through the electrolyte to the anode. Carbonaceous gas stemming from the PSA (contained in the tail gas; “tail gas” is herein sometimes also referred to as “off-gas”) typically comprising CO₂ and additional CO, H₂ and reformable fuels, especially methane CH₄, which may also stem from the PSA or may be added separately, are sent to the anode with steam so that the following reactions take place:

CH₄+H₂O→3H₂+CO

H₂+CO₃²⁻→CO₂+H₂O+2e−

CO+CO₃²⁻→2 CO₂+2e−

It is seen that CO₂ is effectively transferred (or separated, or pumped) from the cathode to the anode of the MCFC. As a result, the outlet stream leaving the anode (the anode outlet stream) has an increased CO₂ concentration. The MCFC therefore acts as an effective CO₂ capture unit (and hence as a carbon capture unit). Apart from CO₂, the anode outlet stream can contain further gases, in particular hydrogen (H₂) and/or carbon monoxide (CO). Additionally, the anode outlet stream may further contain water (H₂O) and/or unreacted components of the reformable fuel, especially methane (CH₄). As used herein, the term “stream” refers to a fluid, wherein a fluid is composed of either gaseous components, or of liquid components, or of a mixture of gaseous and liquid components. The anode outlet stream regularly comprises gaseous components and may in some cases consist of gaseous components. As such, the anode outlet stream is preferably an at least partially gaseous stream and is more preferably a completely gaseous stream.

A fluid communication according to the present invention allows an active or passive transfer of a fluid from a first physical device (e.g., PSA, fuel cell, means, units, etc.) of the carbon capture system to a second physical device (e.g., PSA, fuel cells, means, units, etc.) of the carbon capture system. An active transfer can for example be achieved using one or more compressors, blowers and/or fans. A passive transfer can for example be achieved using gravity. As used herein, a fluid is composed of either gaseous components, or of liquid components, or of a mixture of gaseous and liquid components. The communication between the first and the second physical device of the carbon capture system can for example be achieved using one or more pipes, tubes, hoses, etc., which connect the first and the second physical device of the carbon capture system. The communication itself does not qualify as a physical device within the meaning of the present invention, and the communication does especially not have an active influence on a fluid transferred therewith. A third and further physical devices may be arranged between the first physical device and the second physical device, provided fluid can still be transferred from the first physical device to the second physical device.

According to the present invention, the anode of the MCFC is in fluid communication with the PSA unit for receiving at least a portion of the tail gas produced by the PSA unit (PSA tail gas) as an inlet stream. The PSA tail gas comprises at least one carbonaceous gas, i.e., at least one carbon-containing gas. The at least one carbonaceous gas is preferably CO₂, CH₄ and/or CO, in particular at least CO₂. The PSA tail gas may thus comprise one of the following gas mixtures: CO/CO₂, CO/CH₄, CO₂/CH₄ and CO/CO₂/CH₄. The PSA tail gas may also comprise alkanes higher than CH₄ of general formula CₙH₂ₙ₊₂ (with n>1) alkenes (general formula CₙH₂ₙ; n>1) and alkynes (general formula CₙH₂ₙ₋₂; n>1), but is preferably free of such higher alkanes, alkenes and/or alkynes.

It has been surprisingly found that by feeding at least a portion of the tail gas of the PSA unit, which comprises at least one carbonaceous gas, in particular at least CO₂, CH₄ and/or CO, more specifically at least CO₂, to the anode of the MCFC, additional CO₂ sent to the cathode of the MCFC can be efficiently transferred and separated as described above so that overall CO₂ can be captured by the inventive carbon capture system in an efficient manner. That is, a particularly CO₂-rich anode outlet stream can be produced with the combination of PSA and MCFC according to the present invention. Further, the use of CO₂ in the operation of the MCFC can simultaneously allow to produce electric energy by the MCFC. The produced electric energy can be used within the carbon capture system itself, for example for at least partially operating a CO₂ separation means. The carbon capture system can thereby advantageously become an at least partially self-supporting carbon capture system. The carbon capture system may thereby advantageously also become an exporter of electricity.

In principle, feeding CO₂ to the anode of an MCFC is counter-intuitive as an MCFC regularly requires CO₂ being present at its cathode side as described above. However, without wishing to be bound by theory, it is assumed that the effects of the tail gas, which comprises at least one carbonaceous gas, being fed to the anode of the MCFC as observed in the present invention are at least partially due to a low to very low concentration (including complete absence) of higher hydrocarbons in the PSA tail gas. There is thus no need for any pre-reforming of the feed sent to the anode, and part of the PSA tail gas including at least one carbonaceous gas can be sent in admixture with further fuel and water directly to the anode for the reforming reaction. This also lowers the requirement for CO₂ to be additionally separated by migrating from the cathode to the anode of the MCFC and hence also reduces the size of the MCFC unit for a given overall carbon capture rate of the process. As a result, the overall concentration of captured CO₂ leaving the MCFC as an anode outlet stream can be increased, which adds to the observed advantageous effects.

Additionally, according to the present invention, the molten carbonate fuel cell (MCFC) is a multi-stage fuel cell (or multi-stage MCFC), preferably a two-stage fuel cell (or two-stage MCFC). As used herein, a multi-stage MCFC is an MCFC in which two or more MCFCs (or MCFC stages) are in fluid communication, constituting a sequence of stages, where fuel and/or oxidant streams are entering in sequence the first and the following stages. Because a multi-stage MCFC is employed, the efficiency of the CO₂ capture can be further improved.

In a multi-stage MCFC, the cathode outlet stream of an upstream cell is used as the cathode inlet stream of the subsequent cell, i.e., the next more downstream cell. As an example, in a two-stage MCFC, the cathode outlet stream of a first (upstream) cell is used as the cathode inlet stream of the second (downstream) cell. When reference is made herein to “a cathode” or “the cathode” without indicating a particular stage, regularly the overall cathode of the MCFC is meant, which is composed of two or more separate cathode portions in series. However, when reference is made herein to a cathode inlet, a cathode inlet stream, a cathode feed, a feed or stream directed to the cathode or the like, this is meant to refer to the first cathode portion of the two or more separate cathode portions in series. Similarly, when reference is made herein to a cathode outlet, a cathode outlet stream, a feed or stream stemming from the cathode or the like, this is meant to refer to the last cathode portion of the two or more separate cathode portions in series.

In the multi-stage fuel cell, the anode outlet stream of an upstream cell is used as the anode inlet stream of the subsequent cell, i.e., the next more downstream cell. As an example, in a two-stage fuel cell, the anode outlet stream of a first (upstream) cell is used as the anode inlet stream of the second (downstream) cell. When reference is made herein to “an anode” or “the anode” without indicating a particular stage, regularly the overall anode of the MCFC is meant, which is composed of two or more separate anode portions in series. However, when reference is made herein to an anode inlet, an anode inlet stream, an anode feed, a feed or stream directed to the anode or the like, this is meant to refer to the first anode portion of the two or more separate anode portions in series. Similarly, when reference is made herein to an anode outlet, an anode outlet stream, a feed or stream stemming from the anode or the like, this is meant to refer to the last anode portion of the two or more separate anodes in series.

Typically, at the first cell, the second cell and potentially further cells, there will be a lower air dilution at the inlet of the cathode and hence a higher CO₂ concentration, which can lead to a higher CO₂ utilisation factor and a higher CO₂ capture rate. A multi-stage MCFC and in particular a two-stage MCFC represents a highly beneficial design to maximise the capabilities of the cells of separating CO₂ and, at the same time, this configuration can also lead to a higher electric power output due to the combined effects of higher electricity output from the cells and lower utilities consumptions for air inlet to the cathode (smaller heat exchanger for air preheating). A multi-stage MCFC and in particular a two-stage MCFC can further result in an overall lower cell area, compared to a single-stage MCFC. Additionally, a multi-stage MCFC and in particular a two-stage MCFC gives the possibility of tuning the voltage of the two stages independently.

Moreover, for the multi-stage MCFC of the carbon capture system according to the present invention a two-stage MCFC is preferred over an MCFC having more than two stages because it achieves a balance between realizing the advantages of a multi-stage MCFC described herein on the one hand, and excessive expenditures for additional stages of the multi-stage MCFC on the other hand.

It is in particular preferred that the molten carbonate fuel cell is a two-stage cell having a first cell and a second cell which are in fluid connection, wherein the fluid connection comprises one or more cooling means and/or one or more mixing means. With such a two-stage fuel cell having one or more cooling and/or mixing means arranged between the two cells, the efficiency of the CO₂ capture may be even further enhanced. In particular, when the fluid connection comprises one or more cooling means, it becomes possible to actively control the cell temperature of the second cell which can improve the overall CO₂ capture efficiency.

In order to achieve the advantages associated with the use of tail gas of the PSA unit as an anode feed, to keep the overall carbon capture system simple and to avoid unnecessary costs, it is preferred that there is no compressor arranged between the pressure swing adsorption unit and the molten carbonate fuel cell, especially not between the pressure swing adsorption unit and an inlet of the anode of the molten carbonate fuel cell. In other words, it is preferred that the pressure swing adsorption unit is downstream thereof not in fluid communication with a compressor which compressor would be downstream thereof furthermore in fluid communication with the molten carbonate fuel cell and especially with an inlet of the anode of the molten carbonate fuel cell. This is different to the system of WO 2021/181249 A1 in which such a compressor is arranged between a pressure swing adsorption unit and an anode of a molten carbonate fuel cell.

In order to achieve the advantages associated with the use of tail gas of the PSA unit as an anode feed, to keep the overall carbon capture system simple and to avoid unnecessary costs, it is preferred that there is no chiller (a cooling means) arranged between the pressure swing adsorption unit and the molten carbonate fuel cell, especially not between the pressure swing adsorption unit and an inlet of the anode of the molten carbonate fuel cell. In other words, it is preferred that the pressure swing adsorption unit is not in fluid communication downstream thereof with a chiller which chiller would be downstream thereof furthermore in fluid communication with the molten carbonate fuel cell and especially with an inlet of the anode of the molten carbonate fuel cell. This is different to the system of WO 2021/181249 A1 in which such a chiller is arranged between a pressure swing adsorption unit and an anode of a molten carbonate fuel cell.

In order to achieve the advantages associated with the use of tail gas of the PSA unit as an anode feed, to keep the overall carbon capture system simple and to avoid unnecessary costs, it is preferred that there is no CO₂ separator arranged between the pressure swing adsorption unit and the molten carbonate fuel cell, especially not between the pressure swing adsorption unit and an inlet of the anode of the molten carbonate fuel cell. In other words, it is preferred that the pressure swing adsorption unit is not downstream thereof in fluid communication with a CO₂ separator which CO₂ separator would be downstream thereof furthermore in fluid communication with the molten carbonate fuel cell and especially with an inlet of with the anode of the molten carbonate fuel cell. This is different to the system of WO 2021/181249 A1 in which such a CO₂ separator is arranged between a pressure swing adsorption unit and an anode of a molten carbonate fuel cell.

In order to achieve the advantages associated with the use of tail gas of the PSA unit as an anode feed, to keep the overall carbon capture system simple and to avoid unnecessary costs, it is more preferred that there is no compressor, no chiller and no CO₂ separator arranged between the pressure swing adsorption unit and the molten carbonate fuel cell, especially not between the pressure swing adsorption unit and an inlet of the anode of the molten carbonate fuel cell. This is different to the system of WO 2021/181249 A1 in which a compressor, a chiller and a CO₂ separator are arranged between a pressure swing adsorption unit and an anode of a molten carbonate fuel cell.

It is preferred that the carbon capture system according to the present invention further comprises a CO₂ removing means upstream the PSA. In other words, such a preferred CO₂ removing means is in fluid communication with the PSA for sending a CO₂-lean stream to the PSA as a feed. With the CO₂ removing means it is possible to effectively remove a substantial portion and potentially even all CO₂ upstream the PSA, typically leaving only CH₄, CO and H₂ in the PSA tail gas which can be fed to the MCFC anode for power production.

It is preferred that the MCFC according to the present invention is configured to run in electricity production mode and/or is configured to not run in electrolysis mode (it does not run in electrolysis mode). In contrast, where an MCFC is configured to run in electrolysis mode, it becomes a molten carbonate electrolysis cell (MCEC) which disadvantageously consumes electric energy instead of producing electric energy as in the present invention. This because in an MCEC, in addition to H₂O and CO₂ electricity is required to perform the reduction reaction at the anode and to produce H₂, CO and carbonate ions CO₃²⁻ according to the following reactions:

CO₂+H₂O+2e−→H₂+CO₃²⁻ (not according to the present invention)

2CO₂+2e−→CO+CO₃²⁻ (not according to the present invention)

On the cathode side of an MCEC, the outlet stream contains CO₂ and O₂ resulting from the transportation of CO₃²⁻ ions through the electrolyte according to the following reaction:

CO₃²⁻½O₂+CO₂+2e−(not according to the present invention)

It is seen that the MCEC is for transferring CO₂ from the anode to the cathode, i.e., opposite to the MCFC of the present invention. Further, an MCEC usually increases the electrical and thermal energy demand of a process in which the MCEC is used. Furthermore, it may be required to utilize a sweeping gas (for example air) to avoid the degradation of the cathode of the MCEC. These disadvantages are avoided when the MCFC according to the present invention is configured to run in electricity production mode and/or is configured to not run in electrolysis mode.

It is preferred that the molten carbonate fuel cell is electrically connected to an electricity consumption means and/or an electricity storage means. More preferably, the electricity consumption means is part of the carbon capture system according to the present invention, more preferably a CO₂ separation means (CO₂ purification means; CO₂ compression means). In particular by making use of the electric energy produced by the carbon capture system within the system itself, the carbon capture system becomes an at least partially self-supporting system. The electric energy produced by the carbon capture system may also be exported to the outside of the system for other use or storage. For example, the produced electric energy may be stored in electricity storage means, more preferably in a primary or secondary battery. By storing the electric energy produced by the carbon capture system, the electric energy can be utilized in a highly variable manner, thereby enhancing the versatility of the carbon capture system.

It is preferred that the carbon capture system according to the present invention comprises a CO₂ separation means which is in fluid communication with the anode of the molten carbonate fuel cell for receiving an outlet stream from the anode (the anode outlet stream), wherein the CO₂ separation means is configured to, i.e., is technically able to, separate CO₂ from the anode outlet stream. The CO₂ separation means is preferably an amine-free CO₂ separation means and is more preferably a solvent-free separation means. By separating CO₂ from the anode outlet stream, the CO₂ separation means produces at least two outlet streams, namely a first stream having a higher CO₂ concentration (a CO₂ rich stream), and a second stream having a lower CO₂ concentration (a CO₂ depleted stream). The CO₂ concentration of the CO₂ rich stream is higher that the CO₂ concentration of the CO₂ depleted stream. Herein, concentration refers to concentration in mol %. By producing the CO₂ rich stream, the CO₂ separation means acts as an effective CO₂ capture unit and further purifies (concentrates) the CO₂ captured with the carbon capture system according to the invention. The CO₂ rich stream is preferably at least partially in a supercritical state and is more preferably completely in a supercritical state. Alternatively, the CO₂ rich stream is preferably an at least partially liquid stream and is more preferably a completely liquid stream. The CO₂ rich stream can be sent to storage means, like one or more containers, so that highly concentrated CO₂ is captured and potentially stored. Such one or more containers are preferably configured for transportation thereof on a ship, a train or a truck. For this, the CO₂ separation means is in fluid combination with the one or more containers. With the CO₂ separation means, the carbon capture system according to the invention can capture CO₂ more efficiently.

It is preferred that the PSA unit is in fluid connection with the CO₂ separation means for receiving an outlet stream from the CO₂ separation means as an inlet stream, more preferably the CO₂ depleted stream. The CO₂ depleted stream may still contain residual H₂, and may further still contain residual CO₂ and potentially CO. The fluid connection between the PSA unit and the CO₂ separation means allows to recirculate the residual H₂, CO and/or CO₂ to the PSA unit. The recirculation can then lead to additional recovery of valuable H₂, and/or additional capture and potential storage of CO₂ which could otherwise disadvantageously be emitted to the environment.

It is preferred that the CO₂ separation means is selected from a membrane unit, a second pressure swing adsorption unit (which is different from the PSA unit the tail gas of which is fed to the anode of the MCFC) and a low temperature phase change separation unit. It is more preferred that the CO₂ separation means is a low temperature phase change separation unit (see for example, Berstad et al., J. Int. Acad. Refrig. Vol. 36, No. 5 (2013), 1403-1416; IEAGHG, 2011. Rotating Equipment for Carbon Dioxide Capture and Storage. IEAGHG report 2010/07). A commercial example of a CO₂ separation means is the Air Liquide Cryocap®. In a low temperature phase change separation unit CO₂ is condensed from the anode outlet stream, i.e., gaseous CO₂ is converted into liquid CO₂, to give a condensed fraction. At the same time, additional components remain mostly gaseous, to give an uncondensed fraction. With a low temperature phase change separation unit, CO₂ can be separated from the anode outlet stream in a particularly effective manner and can be captured in advantageously high purity (high concentration).

It is preferred that the carbon capture system according to the present invention further comprises a (first) water-gas-shift reactor (WGS reactor) between the anode of the MCFC and the CO₂ separation means. Such a WGS reactor can receive at least a portion of the anode outlet stream, for which the WGS reactor is in fluid communication with the anode of the MCFC. The anode outlet stream may still contain residual CO, in particular CO which is not oxidized at the MCFC anode or is produced according to the reaction CH₄+H₂O→3H₂+CO. The WGS reactor may convert such CO at least partially into CO₂. The WGS reactor can then send this CO₂ to the CO₂ separation means for capturing and potentially storing the CO₂, thereby further enhancing the efficiency of the overall CO₂ capture. For this, the WGS reactor is in fluid communication with the CO₂ separation means.

It is preferred that the CO₂ separation means allows for a separation of CO₂ having a purity of 95 mol % or more, more preferably of 96 mol % or more, still more preferably of 97 mol % or more, even more preferably of 98 mol % or more and most preferably of 99 mol % or more. With such a CO₂ separation means, an advantageous CO₂ capture can be achieved.

It is preferred that the PSA unit is in fluid connection with a steam methane reformer (SMR) for receiving an outlet stream from the steam methane reformer as an inlet stream.

In a steam methane reformer, steam, i.e., gaseous water or H₂O_{(g)}, is reacted with one or more hydrocarbons to basically yield H₂ and CO. The one or more hydrocarbons typically comprise methane (CH₄), and more preferably a majority of methane, for example more than 50 mol % CH₄, more preferably more than 60 mol % CH₄, even more preferably more than 70 mol % methane, still more preferably more than 80 mol % CH₄ and most preferably more than 90 mol % CH₄. Taking CH₄ as a representative fuel, the steam methane reforming reaction is: CH₄+H₂O→3H₂+CO. The resulting gas mixture is preferably sent to a (second) WGS reactor to produce additional H₂ and CO₂. For this, the SMR is in fluid connection with a WGS reactor, and the WGS reactor is in fluid connection with the PSA unit. In other words, the WGS reactor is arranged downstream of the SMR, and the WGS reactor is arranged upstream of the PSA unit. The second WGS reactor may be used together with one or more further WGS reactors downstream of the second WGS reactor. The one or more further WGS reactors downstream of the second WGS reactor are preferably operated at decreasing temperatures. Typically, fuel gas is combusted with air in a furnace of the SMR to provide heat for the SMR reactions, producing a flue gas containing CO₂ diluted in N₂ and O₂ from the combustion air.

Further, when hydrocarbons (like natural gas) are sent to the preferable SMR, this typically results downstream in excess PSA tail gas (or PSA off gas) that can be advantageously used in the MCFC in the configuration of the present invention. More specifically, it is sufficient that the MCFC is fed with PSA tail gas only, so that there is no need of feeding additional natural gas. Conversely, in WO 2021/181249 A1, natural gas is also fed to the MCFC which typically involves the need of a pre-treatment (e.g., desulfurization, pre-reforming) before the MCFC.

A production of hydrogen by SMR can ultimately result in high amounts of CO₂ of as high as about 10 kgCO₂/kgH₂. The stream leaving the SMR (the SMR outlet stream) and more preferably the stream leaving the WGS reactor (the WGS outlet stream), which contains such high amounts of CO₂, serves as an input stream for the PSA unit of the carbon capture system. The PSA unit further purifies the received H₂ to give the product gas, and the PSA unit concentrates the received carbonaceous gas(es) (in particular CO₂, CH₄, and/or CO) to give the tail gas. The flue gas from SMR is sent to the cathode of the MCFC wherein CO₂ is separated by transfer from the cathode to the anode. The tail gas is then sent to the anode of the MCFC as carbon-rich fuel. According to the present invention, the CO₂ produced by the SMR can thus advantageously be captured efficiently and an emission thereof to the environment can be prevented, while simultaneously generating electric energy.

As described above, the PSA tail gas, which comprises at least one carbonaceous gas, in particular CO₂, CH₄, and/or CO, and preferably comprises CO₂, is at least partially sent to the anode of the MCFC. A further part of the PSA tail gas (containing for example 50/25/15/10 mol % CO₂/H₂/CO/C₁) may preferably be mixed with additional natural gas, and the resulting mixture may preferably be used as additional fuel in the SMR to provide heat for the highly endothermic SMR reactions. On the other hand, using an MCEC outlet stream as a combustion agent in an SMR furnace, as discussed in WO 2017/190066 A1 and by A. Monforti Ferrario et al., would result in dilution of the produced CO₂ with nitrogen, which would then require undesirable and inefficient downstream polishing steps, i.e., additional purification steps.

Subject of the invention is also a method of capturing carbon, comprising:
producing a product gas and a tail gas by pressure swing adsorption, wherein the tail gas comprises at least one carbonaceous gas, and
feeding at least a portion of the tail gas as an inlet stream to an anode of a molten carbonate fuel cell (MCFC), wherein the molten carbonate fuel cell is a multi-stage fuel cell,
wherein the molten carbonate fuel cell produces electric energy and transfers CO₂ from a cathode to the anode.

The preferred embodiments of the inventive carbon capture system described herein including the claims are likewise preferred for this inventive method in an analogous manner. With such a method, CO₂ can be captured efficiently. In particular, when the CO₂ is part of a gas mixture resulting from a hydrogen production (which mixture is subjected to the pressure swing adsorption), the CO₂ can be separated from the hydrogen and can be captured efficiently. Further, using the PSA tail gas at least partially as an anode feed for the MCFC can allow to simultaneously produce electric energy by the MCFC. The produced electric energy can be used within the method of capturing carbon itself, for example for CO₂ separation, in particular by compression. The inventive method of capturing carbon can thereby advantageously become an at least partially self-supporting method of capturing carbon.

Subject of the invention is also a use of the inventive carbon capture system for capturing CO₂. The preferred embodiments of the inventive carbon capture system described herein including the claims are likewise preferred for this inventive use in an analogous manner. With such a use, CO₂ can be captured efficiently. Moreover, when the CO₂ is part of a gas mixture resulting from a hydrogen production, the CO₂ can be separated from the hydrogen and can be captured efficiently. Further, using the PSA tail gas at least partially as an anode feed for the MCFC of the system can allow to simultaneously produce electric energy by the MCFC. The produced electric energy can be used within the use for capturing carbon itself, for example for CO₂ separation, in particular by compression. The inventive use for capturing carbon can thereby advantageously become an at least partially self-supporting use.

Subject of the invention is also a use of a pressure swing adsorption unit and/or a molten carbonate fuel cell in a carbon capture system according to the invention, or in a method of capturing carbon according to the invention. The preferred embodiments of the inventive carbon capture system described herein including the claims are likewise preferred for this inventive use in an analogous manner. With such a use, CO₂ can be captured efficiently. Moreover, when the CO₂ is part of a gas mixture resulting from a hydrogen production, the CO₂ can be separated from the hydrogen and can be captured efficiently with this inventive use. Further, using the PSA tail gas at least partially as an anode feed for the MCFC of the system can allow to simultaneously produce electric energy by the MCFC. The produced electric energy can be used within the carbon capture system itself, for example for CO₂ separation, in particular by compression. This inventive use can thereby advantageously become an at least partially self-supporting use.

Subject of the invention is also CO₂ captured with a carbon capture system according to the invention, or captured with a method of capturing carbon according to the invention, or captured by the use of the inventive carbon capture system for capturing CO₂ according to the invention. The preferred embodiments of the inventive carbon capture system described herein including the claims are likewise preferred for this inventive CO₂. Such CO₂ may be captured in a particularly effective manner and may further help to produce electric energy. Additionally, emission of such captured CO₂ into the atmosphere can be prevented.

### BRIEF DESCRIPTION OF THE DRAWINGS

FIG. 1 shows a basic embodiment of a carbon capture system according to the invention.

FIG. 2 shows a preferred embodiment of a carbon capture system according to the invention.

FIG. 3 shows another preferred embodiment of a carbon capture system according to the invention.

FIG. 4 shows another preferred embodiment of a carbon capture system according to the invention.

FIG. 5 shows an embodiment of a carbon capture system as used in the experimental section.

FIG. 6 shows a further embodiment of a carbon capture system as used in the experimental section.

### EXEMPLARY EMBODIMENTS

Exemplary embodiments of the present invention are described with reference to the accompanying figures. Where arrows are used, the rectangular end represents the “upstream” side or position, while the arrow end represents the “downstream” side or position.

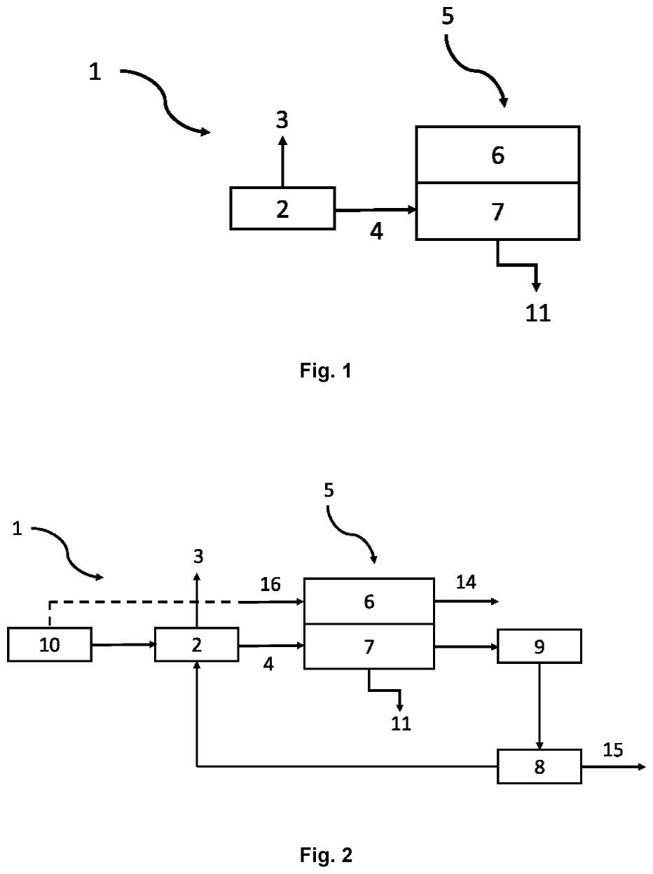

FIG. 1 shows a basic embodiment of a carbon capture system 1. The carbon capture system 1 comprises a pressure swing adsorption unit 2 (PSA unit 2) which produces a product gas 3 and a tail gas 4 comprising at least one carbonaceous gas. The tail gas 4 regularly comprises CO₂ and typically further comprises CH₄ and CO as carbonaceous gas(es). The carbon capture system 1 further comprises a molten carbonate fuel cell 5 (MCFC), which although not explicitly shown is a multi-stage MCFC. The MCFC 5 comprises two electrodes, namely a cathode 6 and an anode 7. The MCFC 5 further comprises an electrolyte between the two electrodes (not shown). The MCFC 5 is further operated such that it generates electricity, i.e., the MCFC 5 produces electric energy 11 (that is, MCFC 5 is configured to run in electricity production mode; alternatively, it can be said that MCFC 5 is configured to run not in electrolysis mode). The anode 7 is in fluid communication with the pressure swing adsorption unit 2 and receives at least a portion of the tail gas 4 as an inlet stream.

FIG. 2 shows a preferred embodiment of a carbon capture system 1. The carbon capture system 1 comprises the same components as the carbon capture system 1 shown in FIG. 1. The carbon capture system 1 of FIG. 2 is used in the context of hydrogen production, more specifically the production of hydrogen via steam methane reforming. Accordingly, the carbon capture system 1 of FIG. 2 comprises a steam methane reformer 10 (SMR 10). The product of this SMR 10, i.e., its outlet stream, is sent via a fluid connection to PSA unit 2 for a separation of CO₂ from H₂, which CO₂ and H₂ are regularly contained in admixture in an outlet stream of a hydrogen production unit like SMR 10. The PSA unit 2 produces a H₂-rich product stream and a tail gas 4. The tail gas 4 regularly comprises CO₂, CH₄, CO and residual H₂ from the steam methane reforming. The cathode inlet stream 16 comprises CO₂ and O₂. The cathode inlet stream may in particular comprise exhaust combustion gases which may optionally be admixed with additional air or may be added separately by recirculating a portion of the PSA tail gas 4 with or without additional air. It is particularly preferred that the cathode inlet stream 16 comprises flue gases deriving from a combustion in the SMR 10 as indicted in FIG. 2 by a dotted line. The CO₂ fed to cathode 6 is transferred from the cathode 6 to the anode 7 to yield a CO₂ depleted cathode outlet stream (thus, CO₂ is captured by system 1 from the cathode inlet stream 16). The carbon capture system 1 of FIG. 2 further comprises a CO₂ separation means 8. This CO₂ separation means 8 is in fluid communication with the anode 7 of MCFC 5 and receives an outlet stream from the anode 7. Further, the CO₂ separation means 8 has such a structure (or configuration) that it separates CO₂ from the outlet stream which comes from anode 7. In FIG. 2, CO₂ separation means 8 is fluidly connected to (in fluid connection with) PSA unit 2. This configuration allows for a recirculation of a CO₂ depleted stream leaving CO₂ separation means 8 to the PSA unit 2 for further hydrogen recovery. Further, in FIG. 2, the CO₂ separation means 8 is a low temperature phase change separation unit which separates CO₂ by liquifying the same under reduced temperature and/or increased pressure. The carbon capture system 1 of FIG. 2 further comprises a water-gas-shift reactor 9 which is located between anode 7 of the MCFC 5 and the CO₂ separation means 8. In the carbon capture system 1 of FIG. 2, CO₂ separation means 8 regularly separates CO₂ which has a purity of at least 95 mol % and typically above 95 mol %. While not shown in FIG. 2, MCFC 5 may be electrically connected to an electricity consumption means and/or an electricity storage means, in particular to a further component of the carbon capture system 1, like the CO₂ separation means 8, the water-gas-shift reactor 9 and/or the steam methane reformer 10, most preferably to the CO₂ separation means 8.

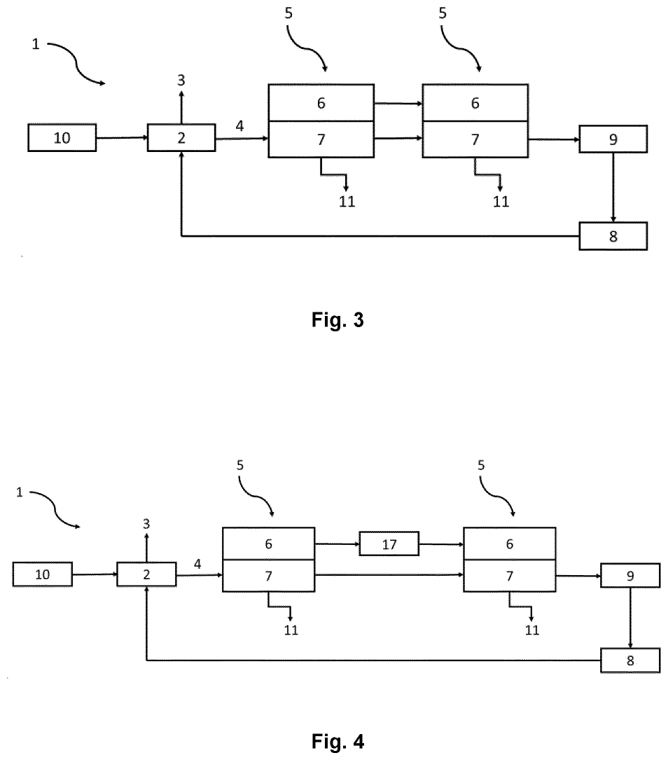

FIG. 3 shows another preferred embodiment of a carbon capture system 1. The carbon capture system 1 comprises the same components as the carbon capture system 1 shown in FIG. 2. In FIG. 3, the MFCF 5 is a two-stage fuel cell as an example for the multi-stage fuel cell. MFCF 5 thus has a first cell and a second cell which are in fluid connection. Specifically, the cathode outlet stream from the first cell is used as a cathode inlet stream for the second cell. Accordingly, the anode outlet stream from the first cell is used as an anode inlet stream for the second cell.

FIG. 4 shows another preferred embodiment of a carbon capture system 1. The carbon capture system 1 comprises the same components as the carbon capture system 1 shown in FIG. 3. In FIG. 4, the fluid connection between the first cell and the second cell comprises a cooling means 17 for cooling fluid transferred from the first cell to the second cell. Specifically, the cathode outlet stream from the first cell is cooled in a cooling means 17 and is thereafter used as a cathode inlet stream for the second cell. Whilst not shown in either FIG. 3 or FIG. 4, it can also be advantageous that the fluid connection between the first cell and the second cell comprises one or more mixing means for mixing fluid transferred from the first cell to the second cell with one or more additional fluids for an improved operation of the second cell.

### Experimental Section

A case study for a carbon capture system (PSA-MCFC integrated plant) used for capturing CO₂ stemming from H₂ production by means of steam methane reforming was performed. The applied method for calculation of the mass and energy balances of respective hydrogen production plants is described hereinafter.

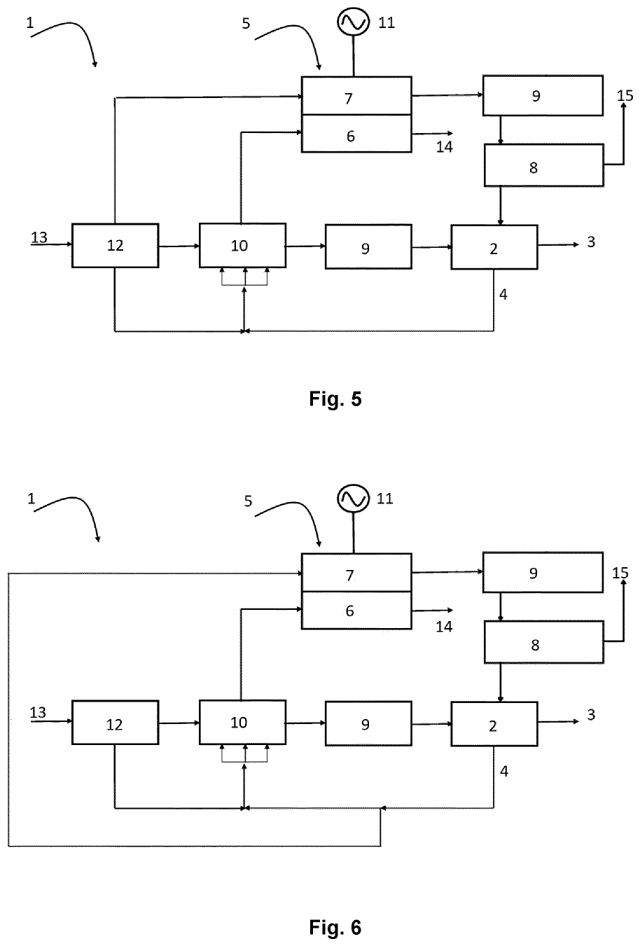

The following cases were analysed:
1. Reference SMR hydrogen plant without CO₂ capture
2. SMR hydrogen plant with CO₂ capture with MCFC fed with natural gas (NGF case).
This case represents a configuration for CO₂ capture with MCFC separator and its configuration is shown in FIG. 5.
3. SMR hydrogen plant with CO₂ capture with MCFC fed with PSA off-gas (OGF case; off-gas, or tail gas, from the PSA sent to anode of MCFC). The configuration of this case is shown in FIG. 6.
4. SMR hydrogen plant with CO₂ capture with two-stage MCFC fed with PSA off-gas (OGF-2 case; off-gas, or tail gas, from the PSA sent to anode of first MCFC). This case is in accordance with the present invention.

The main calculation assumptions are included in the next sections, along with the description of the assessed cases.

### Technical Description of the PSA-MCFC Integrated Plant

Reference SMR without CO₂ Capture

The base case SMR configuration without CO₂ capture consists of a fired tubular reforming system for combined H₂ production, electricity generation and steam export. This system is aimed at producing 100,000 Nm³/h of H₂ from natural gas (NG), the composition of which is reported in Table 1. In particular, the system includes the following unit operations: a desulfurization unit, an adiabatic pre-reformer, a fired tubular steam reformer, a water gas shift (WGS) section and a pressure swing adsorption (PSA) unit. Input data for the SMR are summarised in Table 2.

TABLE 1
Specifications of the NG considered for performance evaluation

| Molar composition | | % mol |
|---|---|---|
| CH₄ | Methane | 89.00 |
| C₂H₆ | Ethane | 7.00 |
| C₃H₈ | Propane | 1.00 |
| C₄H₁₀ | Butane | 0.10 |
| C₅H₁₂ | Pentane | 0.01 |
| CO₂ | Carbon | 2.00 |
| | dioxide | |
| N₂ | Nitrogen | 0.89 |
| Molar mass | kg/kmol | 18.018 |
| Lower heating value | MJ/kg | 46.482 |
| Higher heating value | MJ/kg | 51.454 |
| CO₂ specific emission | gCO₂/MJ_{LHV} | 56.99 |

TABLE 2
Summary of the main input data for SMR

| Unit | Component | Parameter | Unit | Value |
|---|---|---|---|---|
| SMR | Pre-reformer | Inlet temperature | ° C. | 490 |
| SMR | Pre-reformer | Pressure | bar | 38 |
| SMR | Pre-reformer | Steam to carbon ratio | — | 3.4 |
| SMR | Reformer | Inlet temperature | ° C. | 620 |
| SMR | Reformer | Outlet temperature | ° C. | 890 |
| SMR | WGS | Inlet temperature | ° C. | 330 |
| SMR | WGS | Inlet pressure | bar | 32 |
| SMR | PSA | Inlet temperature | ° C. | 31 |
| SMR | PSA | Inlet pressure | bar | 30 |
| SMR | PSA | Hydrogen recovery | % | 90% |
| SMR | H₂ compressor | Isentropic efficiency | % | 84% |
| SMR | H₂ compressor | Mechanical and electrical | % | 94% |
| | | efficiency | | |
| SMR | Comb. air fan | Isentropic efficiency | % | 80% |
| SMR | Comb. air fan | Mechanical and electrical | % | 94% |
| | | efficiency | | |
| SMR | Water pump | Isentropic efficiency | % | 70% |
| SMR | Water pump | Mechanical and electrical | % | 84% |
| | | efficiency | | |
| SMR | LP steam | Pressure/temperature | bar/° C. | 6/160 |
| SMR | MP steam | Pressure/temperature | bar/° C. | 40/348 |
| SMR | HP steam | Pressure/temperature | bar/° C. | 100/485 |
| SMR | LP/HT turbine | Isentropic efficiency | % | 87% |
| SMR | LP/HP turbine | Mechanical and electrical | % | 99.6% |
| | | efficiency | | |

Firstly, the NG is treated to remove sulfur that may poison the reformer catalyst. Desulfurization is usually carried out in a two-stage process operating in the 300-400° C. temperature range. A portion of the produced H₂ is mixed to NG in order to drive at a satisfactory rate (2%ₘₒₗ of H₂ in the mixture NG-H₂) the hydrogenation reactions of organic sulfur compounds to H₂S. H₂S is then removed in a zinc oxide adsorption bed, capable to reduce sulfur concentration to below 100 ppb.

NG is then mixed with steam (with a steam to carbon ratio equal to 3.4) and sent to a pre-reformer, where a nickel-based catalyst decomposes complex hydrocarbons to avoid cracking in the downstream fired tubular reformer and also to favour a more uniform feeding of the reformer, independently from the composition of the original feedstock. The pre-reformer is modelled as an adiabatic reactor at chemical equilibrium, with an inlet feed at 490° C. and 37 bar.

The pre-reformed charge is sent to a fired tubular steam reformer, which is composed of a furnace whose burners radiate on tubes filled with nickel-based catalyst to provide the heat required to sustain the endothermic methane reforming reaction. The reformer is modelled at chemical equilibrium, with exit temperature and pressure of 890° C. and 35 bar. The air flowrate to the burners is set to obtain a molar fraction of O₂ in the flue gases equal to 1.5%ₘₒₗ. The reformer fuel is constituted by a mixture of NG and PSA off-gas (tail gas).

At the SMR exit, the reformed syngas is cooled down by producing steam and fed to a WGS reactor at 330° C., which is calculated as an adiabatic reactor at chemical equilibrium. Subsequently, the syngas is cooled down to nearly ambient temperature and sent to the PSA section.

### PSA Section

A 90% hydrogen recovery efficiency is assumed for the PSA according to current industrial practice. The off-gas stream from the PSA is burned with additional NG in the SMR furnace to sustain reforming.

### Heat Recovery and Steam Cycle

A heat recovery system is in place to: (i) cool down the SMR flue gas from the assumed furnace exit temperature of 1010° C. to 142° C. and provide heat to the pre-reformer charge and to the natural gas inlet, to pre-heat combustion air (425° C.) and generate high pressure (HP) steam (100 bar, 485° C.); and (ii) cool down the hot syngas produced by the SMR at 890° C. to 171° C. to produce HP steam.

The steam cycle consists of a high-pressure turbine, delivering medium pressure (MP) steam at 40 bar and 348° C. to a low pressure (LP) backpressure turbine (exit at 6 bar, 160° C.), which provides LP steam to the refinery. Both turbines have an isentropic efficiency of 87% and a mechanical and electrical efficiency of 99.6%. Liquid water is assumed to be fed to the heat recovery section at 151° C., i.e. as condensate returning form thermal users in the refinery.

Case Study NGF: Integrated PSA-MCFC with NG Feed to Cell Anode

The integration of an MCFC requires some modifications to the reference SMR reported in the previous section. The main modifications are the addition of an MCFC system, followed by a low temperature CO₂ purification unit (CPU) to generate a high purity CO₂ stream and recover the H₂. A greenfield design approach has been assumed, entailing the preference of feeding the SMR flue gases to the cell cathode at high temperature to comply with the MCFC design inlet temperature of 575° C. As a result, the preheating requirements in the SMR section are now largely fulfilled by the hot cathode off-gas rather than by the hot flue gases from the SMR furnace. The distinctive element of this case study (natural gas feed: NGF case) is represented by the choice of feeding the cell anode with additional NG.

### CO₂ Separation by MCFC

Input data for the MCFC are summarised in Table 3. The MCFC unit consists of an anode, a cathode and a reforming layer upstream the anode, while a pre-reformer (upstream the MCFC) and a WGS section (downstream the MCFC) complete the separation system. The flue gases deriving from the combustion in the SMR section are sent to the MCFC cathode, while the anode feed is constituted by NG with the same characteristics as that reported in Table 1.

The flue gases deriving from the combustion in the SMR (74 kg/s) are firstly mixed with air (264 kg/s). The temperature of this air is determined to obtain 575° C. after mixing with the flue gases. The flowrate of air is determined to keep the cell outlet temperature constant and equal to the design value of 645° C. Then, the mixture of flue gases and air is sent to the MCFC cathode.

The amount of CO₂ permeating from the cathode to the anode is set to obtain a CO₂ molar fraction in the cathode exhaust gas equal to 1% mol. H₂O permeation from the cathode to the anode, alongside O₂ permeation, is taken into account by imposing a value of transference number equal to 0.75. Hence, for each mole of CO₂ permeating, there will be accordingly ⅓ moles of H₂O and (1+⅓)/2=⅔ moles of O₂ co-permeating. At the exit, the cold cathode exhaust is vented to the atmosphere at 1.01 bar and 168° C., after heat recovery.

The NG fed to the anode (3.46 kg/s) is heated up to 600° C. and sent to the adiabatic pre-reformer, that operates at 4 bar with a steam to carbon ratio equal to 2.1. The target steam to carbon ratio is obtained by mixing 7.73 kg/s of LP steam. The pre-reformed stream exits at 404° C., is heated up again up to 450° C. and fed to the MCFC, where it mixes with the CO₂, H₂O and O₂ permeating from the cathode to the anode to produce the anode off-gas at 645° C. The hot anode exhaust gas is cooled by generating LP steam and pre-heating the NG, the pre-reformer charge and the reformer charge. Finally, the anode exhaust gas is further cooled down to ambient temperature to condense water and sent to the CPU.

TABLE 3
Summary of the main input data for MCFC

| Unit | Component | Parameter | Unit | Value |
|---|---|---|---|---|
| MCFC | Cathode | Inlet temperature | ° C. | 575 |
| MCFC | Cathode | Outlet temperature | ° C. | 645 |
| MCFC | Cathode | CO₂ concentration in cathode | % | 1% |
| | | exhaust | | |
| MCFC | Pre- | Inlet temperature | ° C. | 600 |
| | reformer | | | |
| MCFC | Pre- | Steam to carbon ratio | — | 2.1 |
| | reformer | | | |
| MCFC | Anode | Inlet temperature | ° C. | 600 |
| MCFC | Anode | Outlet temperature | ° C. | 645 |
| MCFC | Cell balance | Fuel utilisation factor | — | 0.75 |
| MCFC | Cell balance | Cell voltage | V | 0.7 |
| MCFC | Cell balance | Heat loss | % LHV | 1% |
| MCFC | WGS | Inlet temperature | ° C. | 330 |
| MCFC | WGS | Inlet pressure | bar | 1 |
| MCFC | Cathode air | Isentropic efficiency | % | 80% |
| | fan | | | |
| MCFC | Cathode air | Mechanical and electrical | % | 94% |
| | fan | efficiency | | |
| MCFC | Water pump | Isentropic efficiency | % | 70% |
| MCFC | Water pump | Mechanical and electrical | % | 84% |
| | | efficiency | | |
| MCFC | Outlet fan | Outlet pressure | bar | 1.01 |
| MCFC | Outlet fan | Isentropic efficiency | % | 80% |
| MCFC | Outlet fan | Mechanical and electrical | % | 94% |
| | | efficiency | | |

### CO₂ Purification Unit (CPU)

The CPU has two key objectives: (i) to separate additional CO₂ to be sent to storage (i.e., in addition to the separation already operated by the MCFC unit); and (ii) to separate a H₂-rich stream to be recovered and purified in the PSA unit of the SMR. Note that in order to keep consistency with the reference SMR case without CO₂ capture, it is here imposed an overall H₂ production (i.e., combining both the direct production from the SMR and the indirect one from the MCFC anode residue) still equal to 100,000 Nm³/h.

Input data for the CPU are summarised in Table 4. In particular, the cold anode residue undergoes a first compression, modelled as a 4-stage compressor with inter-cooling with fixed discharge pressure of 32 bar (isentropic efficiency of 84%, mechanical and electrical efficiency of 94%). The resulting stream is then treated in a two-stage phase separation process constituted by two CO₂ separation drums, two expansion valves and two heat exchangers. The resulting flowrates are a CO₂-depleted residue to be sent to the PSA unit of the SMR, and two high-purity CO₂ streams which are then mixed (at 15 bar) and compressed through a 2-stage intercooled compressor with fixed discharge pressure of 100 bar (isentropic efficiency of 84%, mechanical and electrical efficiency of 94%). Then, the CO₂-rich stream is cooled down to ambient temperature and pumped out at 150 bar (isentropic efficiency of 80%, mechanical and electrical efficiency of 84%). The result is a high purity (99%ₘₒₗ of CO₂), HP (150 bar) CO₂ stream (24.93 kg/s), to be sent to storage.

TABLE 4
Summary of the main input data for CPU

| Unit | Component | Parameter | Unit | Value |
|---|---|---|---|---|
| CPU | Compressor(s) | Isentropic efficiency | % | 84% |
| CPU | Compressor(s) | Mechanical and electrical | % | 94% |
| | | efficiency | | |
| CPU | Compressor(s) | Number of stages | — | 4 + 2 = 6 |
| CPU | Compressor(s) | Final pressure before CO₂ | bar | 100 |
| | | pump | | |
| CPU | CO₂ pump | Outlet pressure | bar | 150 |
| CPU | CO₂ pump | Isentropic efficiency | % | 80% |
| CPU | CO₂ pump | Mechanical and electrical | % | 84% |
| | | efficiency | | |
| CPU | Heat | DT min heat exchangers | ° C. | 3 |
| | exchange | | | |
| CPU | Drum vessel 1 | Outlet temperature | ° C. | −33.0 |
| CPU | Drum vessel 1 | Outlet pressure | bar | 31.7 |
| CPU | Drum vessel 2 | Outlet temperature | ° C. | −47.0 |
| CPU | Drum vessel 2 | Outlet pressure | bar | 31.4 |

Case Study OGF: Integrated PSA-MCFC with PSA Off-Gas Feed to Cell Anode (Inventive Case Study I)

The configuration involves the possibility to exploit part of the PSA off-gas as (tail gas) feed to the MCFC anode. This can be achieved in the “off-gas feed” (OGF) case, by introducing a split in the PSA off-gas, which can be directed towards the MCFC anode and to the SMR burners. Thanks to the lack of higher hydrocarbons in the PSA off-gas, this configuration allows to eliminate the MCFC pre-reformer unit hence, the anode charge (with the correct steam to carbon ratio equal to 2.1) can be sent directly to the MCFC.

Case Study OGF-2: Two-Stage MCFC with Inter-Cooling (Inventive Case Study II)

Under the same technical assumptions already described for case study OGF (i.e., anode fed with PSA off-gas; or tail gas), an alternative design configuration (i.e., OGF-2) entails the use of a two-stage MCFC (i.e., two cells in series) with inter-cooling placed between the two cathodes (see FIG. 4). In particular, the cathode residue 1 from cell 1 is cooled down from 645° C. to 575° C., the latter representing the design inlet temperature to the second cathode of the second cell. The inter-cooler is constituted by a heat exchanger which produces HP steam at 485° C. and 100 bar, which is added up to the steam already produced by the heat integration in the SMR. Both cells are described in terms of heat balances and they entail the possibility to impose separately the desired values of cell potential (for a given fuel utilisation factor FU), in order to optimise their overall performance. As it will be shown in the results section, this option determines the possibility to reduce the flow rate of dilution air to control the cell temperature and consequently improve the overall CO₂ capture efficiency to over 95% with the assumed CO₂ concentration at cathode outlet.

### Results: Technical Performance

### Assumptions in the Calculation of Key Performance Indicators.

Because of the different electricity balance and steam export among the assessed cases, a consistent comparison must take into account the indirect fuel consumption and indirect CO₂ emissions associated to the electricity and steam flows. Ultimately, this allows the calculation of basically equivalent key performance indicators (KPIs) that rely on the definition of two reference scenarios (Table 5). In both Scenario 1 and Scenario 2, reference thermal power is assumed to be produced through an NG boiler with efficiency of 90%, combustion emission factor of 2.7 kg CO₂/kg NG and resulting carbon intensity of 0.064 kg CO₂/MJth. Differently, the two scenarios differ for what concerns power generation. In Scenario 1, the reference electric power is assumed to be generated by an NG combined cycle (NGCC) without CO₂ capture, with overall efficiency of 60% and resulting carbon intensity of 345.0 kg CO₂/MWhel (i.e., 0.097 kg CO₂/MJel). In Scenario 2, the reference electric power is generated with a NGCC with CO₂ capture hence, overall efficiency lowered to 51% and resulting carbon intensity equal to 35.0 kg CO₂/MWhel (i.e., 0.010 kg CO₂/MJel).

TABLE 5
Assumptions on the reference scenarios for
the calculation of equivalent emissions
ASSUMPTIONS
Scenario 1: Reference
NGCC without CO₂ capture
Scenario 2: Reference
NGCC with CO₂ capture

| | | Scenar- | Scenar- | |
|---|---|---|---|---|
| | | io 1 | io 2 | |
| NGCC plant efficiency | % | 60.0% | 51.0% | Reference |
| NGCC electricity carbon | kg CO₂/MWh | 348.0 | 35.0 | electricity |
| intensity | | | | |
| NGCC electricity carbon | kg CO₂/MJ | 0.097 | 0.010 | |
| intensity - εₑₗ | | | | |
| NG boiler efficiency | % | 90.0% | 90.0% | Reference |
| NG combustion emission | kg CO₂/kg NG | 2.7 | 2.7 | heat |
| factor | | | | |
| NG combustion emission | kg CO₂/GJ | 58.0 | 58.0 | |
| factor | LHV | | | |
| NG boiler carbon | kg CO₂/MJ | 0.064 | 0.064 | |
| intensity - εₜₕ | | | | |

The key performance indicators that will be employed to compare the different case studies analysed are the H₂ production efficiency (i.e., ηH₂ [%]), the equivalent H₂ production efficiency (i.e., ηH₂,eq [%]), the carbon capture rate (i.e., CCR [%]), and the specific consumption of primary energy per unit of CO₂ avoided (i.e., SPECCA [MJ/kg]). On the one hand, both ηH₂ and CCR evaluate the direct performance of the plant (in terms of H₂ production and CO₂ capture) without considering the effect of indirect fuel consumption and emissions, and are defined as:
where \dot{m}H₂ [kg/s],\dot{m}NG [kg/s] and \dot{m}CO₂ [kg/s] are the mass flowrates of H₂, NG and CO₂, respectively, while LHV_{H2} [=119.91 MJ/kg] and LHV_{NG} [=46.498 MJ/kg] are the lower heating values of H₂ and NG. In particular, CCR of Equation (2) represents the CO₂ capture efficiency hence, it measures the amount of carbon that is effectively captured with respect to the total carbon inlet to the plant. On the other hand, indirect emissions are taken into account in the definition of ηH₂,eq and SPECCA:

The equivalent-related parameters in Equations (3,4) take into account the energetic contributions of the co-production of thermal power Qₜₕ [MWₜₕ] and/or electricity Wₑₗ [MWₑₗ] through the conversion efficiencies defined for Scenario 1 and Scenario 2 (Table 5). SPECCA of Equation (4) gives an estimate of the additional amount of energy that is required to avoid the emissions to the atmosphere of a reference unit of CO₂ thus, it compares the analysed scenarios with the SMR case without capture, the latter set as benchmark emission case study. As they are defined in Equation (4), SPECCA values are comparable among the analysed case studies since they entail the same overall H₂ output, otherwise both NG consumptions and equivalent CO₂ emissions would need to be scaled over the H₂ production. In particular, the equivalent natural gas input NG_{capt,eq} [MW] and NG_{no capt,eq} [MW] of Equation (3) are defined as the NG net thermal output in the case of considering or not carbon capture:
whereas equivalent CO₂ emissions \dot{m}CO₂,capt,eq \dot{m}_{CO-cavt,ea} [kg/s] and \dot{m}CO₂,no capt,eq \dot{m}_{CO-cavt,ea} [kg/s] of Equation (4) are defined in general as the emitted CO₂ flow \dot{m}CO₂,emission \dot{m}_{CO-cavt,ea} decreased by the emissions avoided as a result of the co-production of electricity Wₑₗ and heat Qₜₕ (calculated through the carbon intensities εₑₗ and εₜₕ reported in Table 5):

### Base Cases: Reference SMR, NGF, OGF

This section details the main results in terms of mass and energy balances, electricity balance, steam balance, CO₂ balance and CO₂ avoidance performance for the following case studies (Table 6):

Reference SMR without CO₂ capture.
NGF case: integrated PSA-MCFC. Cell potential set equal to 0.7 V, fuel utilisation factor of 0.75.
OGF case: integrated PSA-MCFC. Cell potential set equal to 0.7 V, fuel utilisation factor of 0.75.

The CO₂ flux throughout the cell reported in Table 6 is defined as the ratio between the mass flow rate of permeating CO₂ and the area of the cell. The CO₂ production density reported in Table 6 is defined as the ratio between the total CO₂ mass flow rate at the anode outlet and the area of the cell. The electric power output from the SMR reference case is equal to 10.4 MWₑₗ. The combined contributions of the SMR steam cycle and of the MCFCs determine larger electric power outputs from the cases NGF (59.1 MWₑₗ) and OGF (22.1 MWₑₗ), with the quantitative difference between NGF and OGF explained by the flow rate of permeating CO₂ across the respective cells (19.6 kg/s for NGF against 8.5 kg/s for OGF). The design steam thermal output from the SMR reference is equal to 23.2 MWₜₕ. The steam thermal output from NGF and OGF case studies are 21.5 MWₜₕ and 24.6 MWₜₕ, respectively.

As for CO₂ capture performances, the OGF system achieves a CCR of 90.3%, while the NGF option entails a slightly worse separation performance (85.0%). Both NGF and particularly OGF exhibit good results in terms of equivalent emissions, with a resulting relative equivalent CO₂ emission closer to 0 kg CO₂ eq/kg H₂ (or even negative, depending on the chosen reference scenario for indirect emissions). The H₂ production efficiency is always lower than in the reference SMR (73.5%), but higher in the OGF case (67.7%) with respect to the NGF case (58.5%). This is due to the additional natural gas input of the MCFC-based plants, needed either in the fuel cell (NGF case) or to compensate the loss of PSA off-gas fuel in the SMR burners (OGF case). The higher natural gas consumption of the MCFC plants involve higher power output and heat export, and overall this leads to slightly lower H₂ equivalent production efficiency (up to 80.4% for NGF and 80.6% for OGF) with respect to the SMR case (up to 83.0%). The good equivalent efficiency and emissions lead to low value of SPECCA (between 0.6 and 1.1 MJ/kg CO₂ for NGF and between 0.5 and 0.6 MJ/kg CO₂ for OGF).

Details of the material balances across the cell for cases NGF and OGF are reported in Table 7. The cathode inlet has larger flowrate in the case NGF (11.63 kmol/s) than OGF (5.95 kmol/s). Both cells are designed to obtain a 1%ₘₒₗ CO₂ concentration at the cathode off-gas, which results in the larger permeation through the cell in NGF (0.89 kmol/s) than OGF (0.38 kmol/s). The permeating flux is composed of CO₂, O₂ and H₂O in fixed ratios. Being designed for NG anodic feed, the NGF case clearly shows a different anode inlet composition with respect to OGF, and in particular the CH₄ contents at the anode and the CO₂ concentration at the cathode are lower than those in case NGF (2.2% for OGF against 8.8% for NGF, and 4.2% for OGF against 4.7% for NGF, respectively).

As for the resulting cell design, the NGF entails a total cell area of 134532.9 m², against 91113.5 m² in the OGF case (i.e., −32%), corresponding to a specific CO₂ flux through the cell¹ of 0.145 (g/s)/m² and of 0.093 (g/s)/m², and CO₂ production densities of 0.196 (g/s)/m² and 0.254 (g/s)/m² for NGF and OGF, respectively. The much higher CO₂ production density (+30%) of the OGF case shows that a correspondingly smaller MCFC is needed for a given overall CO₂ capture rate in the plant.

Due to the higher capture rate, the higher H₂ production efficiency, the lower SPECCA, and lower total cell area the OGF case is considered superior to the NGF case.

TABLE 6
Technical performance of the analysed base cases

| | | SMR | NGF | OGF | OGF-2 | |
|---|---|---|---|---|---|---|
| | | No | SINGLE | SINGLE | 2-STAGE | |
| | | capture | CELL | CELL | CELL | |
| MCFC cell 1 potential | V | — | 0.70 | 0.70 | 0.65 | MCFC |
| MCFC cell 2 potential | V | — | — | — | 0.60 | |
| Area cell 1 | m2 | — | 134532.9 | 91113.5 | 37879.2 | |
| Area cell 2 | m2 | — | — | — | 12914.5 | |
| Total area cell 1 + cell 2 | m2 | — | 134532.9 | 91113.5 | 50793.7 | |
| CO2 utilisation factor | % | — | 81.71% | 77.5% | 87.1% | |
| Fuel utilisation factor | % | — | 75.0% | 75.0% | 70.0% | |
| CO2 concentration after FTR combustion | % | — | 22.0% | 11.8% | 11.0% | |
| CO2 concentration at cathode inlet | % | — | 4.7% | 4.2% | 6.3% | |
| CO2 concentration at anode outlet | % | — | 74.8% | 84.8% | 81.8% | |
| (dry basis) | | | | | | |
| CO2 concentration at CPU inlet (dry basis) | % | — | 76.2% | 85.5% | 82.7% | |
| CO2 production density cell 1 | (g/s)/m2 | — | 0.196 | 0.254 | 0.427 | |
| CO2 production density cell 2 | (g/s)/m2 | — | — | — | 0.478 | |
| CO2 flux throughout fuel cell 1 | (g/s)/m2 | — | 0.145 | 0.093 | 0.178 | |
| CO2 flux throughout fuel cell 2 | (g/s)/m2 | — | — | — | 0.133 | |
| CO2 permeation through cell 1 | kg/s | — | 19.6 | 8.5 | 6.8 | |
| CO2 permeation through cell 2 | kg/s | — | — | — | 1.7 | |
| Relative CO2 permeation over storage | % | — | 78.6% | 37.2% | 35.7% | |
| Natural gas input (SMR + MCFC) | kg/s | 8.76 | 11.02 | 9.51 | 9.45 | Mass/energy |
| Natural gas thermal input (SMR + MCFC) | MWLHV | 407.3 | 512.4 | 442.2 | 439.4 | balances |
| Natural gas input to SMR | % | 100.0% | 68.6% | 100.0% | 100.0% | |
| of which to FTR combustion | % | 17.4% | 17.2% | 28.2% | 28.8% | |
| of which to SMR reforming | % | 82.6% | 82.8% | 71.8% | 71.2% | |
| Natural gas input to MCFC anode | % | 0.0% | 31.4% | 0.0% | 0.0% | |
| PSA off-gas | MWLHV | 97.1 | 90.8 | 95.0 | 94.6 | |
| of which to FTR combustion | % | 100.0% | 100.0% | 18.9% | 12.2% | |
| of which to MCFC anode | % | 0.0% | 0.0% | 81.1% | 87.8% | |
| Hydrogen output | Nmc/h | 100000 | 10000 | 100000 | 100000 | |
| Hydrogen thermal output | MWLHV | 299.5 | 299.5 | 299.5 | 299.5 | |
| LP + HP steam turbine electric power | MWel | 12.2 | 10.5 | 11.1 | 9.2 | Electricity |
| output | | | | | | balance |
| MCFC cell 1 electric power output (net) | MWel | — | 74.2 | 32.1 | 23.8 | |
| MCFC cell 2 electric power output (net) | MWel | — | — | — | 5.6 | |
| Auxiliaries | MWel | −1.2 | −9.1 | −5.0 | −2.4 | |
| CPU compressors, boosters, | MWel | — | −15.2 | −11.7 | −13.1 | |
| pump el. p. cons. | | | | | | |
| Net electric power output | MWel | 10.4 | 59.1 | 22.1 | 19.8 | |
| Steam export at 160° C./6 bar | kg/s | 10.9 | 9.9 | 11.3 | 12.1 | Steam |
| Steam thermal output | MWth | 23.2 | 21.5 | 24.6 | 26.2 | |
| CO2 emitted | kg CO2/s | 23.2 | 4.4 | 2.5 | 1.3 | CO2 |
| CO2 captured | kg CO2/s | 0.0 | 24.9 | 22.8 | 23.8 | balance |
| Specific CO2 emission | kg CO2em/kg | 9.29 | 1.75 | 0.98 | 0.50 | |
| | H2 | | | | | |
| Hydrogen production efficiency | % | 73.5% | 58.5% | 67.7% | 68.2% | Performance |
| Carbon capture rate (CCR) | % | 0.0% | 85.0% | 90.3% | 95.0% | |
| Relative equivalent CO2 emissions | kg CO2eq/kg | 8.3 | −1.1 | −0.5 | −1.0 | Scenario 1 |
| | H2 | 9.2 | 1.5 | 0.8 | 0.3 | Scenario 2 |
| Hydrogen equivalent prod. efficiency | % | 82.3% | 76.8% | 79.2% | 79.4% | Scenario 1 |
| | | 83.0% | 80.4% | 80.6% | 80.6% | Scenario 2 |
| SPECCA | MJ/kg CO2 | 0.0 | 1.1 | 0.6 | 0.6 | Scenario 1 |
| | | 0.0 | 0.6 | 0.5 | 0.5 | Scenario 2 |

TABLE 7
Material balances across the cell for NGF and OGF

| | | | | | | | | | | TOT |
|---|---|---|---|---|---|---|---|---|---|---|
| | | AR | CH4 | CO | CO2 | H2 | H2O | N2 | O2 | [kmol/s] |
| NGF | | | | | | | | | | |
| Cathode | Inlet | 0.9 | 0.0 | 0.0 | 4.7 | 0.0 | 4.3 | 73.5 | 16.7 | 11.63 |
| Cathode | Outlet | 0.9 | 0.0 | 0.0 | 1.0 | 0.0 | 3.3 | 79.5 | 15.3 | 10.73 |
| Permeation | | 0.0 | 0.0 | 0.0 | 49.8 | 0.0 | 16.6 | 0.0 | 33.6 | 0.89 |
| Anode | Inlet | 0.0 | 8.8 | 6.4 | 8.6 | 49.7 | 26.3 | 0.2 | 0.0 | 0.88 |
| Anode | Outlet | 0.0 | 0.0 | 3.3 | 36.9 | 9.0 | 50.7 | 0.1 | 0.0 | 1.62 |
| OGF | | | | | | | | | | |
| Cathode | Inlet | 0.9 | 0.0 | 0.0 | 4.2 | 0.0 | 6.8 | 74.1 | 14.0 | 5.95 |
| Cathode | Outlet | 0.9 | 0.0 | 0.0 | 1.0 | 0.0 | 6.1 | 79.2 | 12.7 | 5.56 |
| Permeation | | 0.0 | 0.0 | 0.0 | 50.0 | 0.0 | 16.7 | 0.0 | 33.3 | 0.38 |
| Anode | Inlet | 0.0 | 2.2 | 12.9 | 34.1 | 24.3 | 25.4 | 1.2 | 0.0 | 0.75 |
| Anode | Outlet | 0.0 | 0.0 | 3.2 | 50.8 | 5.0 | 40.1 | 0.8 | 0.0 | 1.04 |

OGF-2: Results of Two-Stage MCFC with Inter-Cooling

This section details the main results in terms of mass and energy balances, electricity balance, steam balance, CO₂ balance and CO₂ avoidance performance for the following case studies (see also Table 6):
OGF: integrated PSA-MCFC SMR. Cell potential set equal to 0.7 V, fuel utilisation factor of 0.75.
OGF-2: integrated PSA-two-stage MCFC. Cell 1 potential set equal to 0.65 V and cell 2 potential equal to 0.6 V, fuel utilisation factor of 0.70.

The use of two cells in series with inter-cooling has a positive effect on the performance of the system in terms of CO₂ separation (CCR increases over 95%, with stable H₂ production efficiency). Case OGF-2 is characterised by a lower air dilution at the inlet of the cathode hence, higher CO₂ concentration, which produces a higher CO₂ utilisation factor (higher than 87%). OGF-2 represents a highly beneficial design to maximise the capabilities of the cells of separating CO₂ and, at the same time, this configuration is also characterised by a higher electric power output due to the combined effects of higher electricity output from the cells and lower utilities consumptions for air inlet to the cathode. The overall result in terms of SPECCA is comparable between cases OGF and OGF-2.

Case OGF-2 (fuel utilisation factor of 70%) is detailed in terms of material balances across the cells in Table 8. The CO₂ concentration at the first cathode inlet is 6.3%, part of it permeates to the first anode (0.16 kmol/s), while the remaining goes to the second cathode (the latter has with an inlet molar fraction of CO₂ of 2.1%). From the second cathode, part of the CO₂ permeates to the second anode (0.04 kmol/s), while the rest is vented with the off-gas (with molar concentration of CO₂ of 1%). As shown in Table 8, the first cathode outlet (3.19 kmol/s) corresponds to the second cathode inlet (3.19 kmol/s), and the first anode outlet (1.06 kmol/s) corresponds to the second anode inlet (1.06 kmol/s).

As for the areas of the cells, OGF-2 configuration is characterised by a total cell area of 50793.7 m2, which is 44% less than the single cell OGF case.

TABLE 8
Material balances across cell 1 and cell 2 for OGF-2 with fuel utilisation of 70%.

| | | | | | | | Mole | | |
|---|---|---|---|---|---|---|---|---|---|
| | | | | | | | fractions [%] | | TOT |
| OGF-2 | AR | CH4 | CO | CO2 | H2 | H2O | N2 | O2 | [kmol/s] |

Cell 1 - DV = 0.65 V - FU = 0.70

| | | | | | | | | | | |
|---|---|---|---|---|---|---|---|---|---|---|
| Cathode | Inlet | 0.9 | 0.0 | 0.0 | 6.3 | 0.0 | 10.6 | 72.5 | 9.7 | 3.50 |
| Cathode | Outlet | 0.9 | 0.0 | 0.0 | 2.1 | 0.0 | 10.0 | 79.5 | 7.4 | 3.19 |
| Permeation | | 0.0 | 0.0 | 0.0 | 50.0 | 0.0 | 16.7 | 0.0 | 33.3 | 0.31 |
| Anode | Inlet | 0.0 | 2.1 | 12.9 | 34.3 | 23.9 | 25.3 | 1.5 | 0.0 | 0.82 |
| Anode | Outlet | 0.0 | 0.0 | 6.1 | 46.6 | 9.4 | 36.7 | 1.2 | 0.0 | 1.06 |

Cell 2 - DV = 0.60 V - FU = 0.70

| | | | | | | | | | | |
|---|---|---|---|---|---|---|---|---|---|---|
| Cathode | Inlet | 0.9 | 0.0 | 0.0 | 2.1 | 0.0 | 10.0 | 79.5 | 7.4 | 3.19 |
| Cathode | Outlet | 1.0 | 0.0 | 0.0 | 1.0 | 0.0 | 9.9 | 81.4 | 6.7 | 3.11 |
| Permeation | | 0.0 | 0.0 | 0.0 | 49.7 | 0.0 | 16.6 | 0.0 | 33.8 | 0.08 |
| Anode | Inlet | 0.0 | 0.0 | 6.1 | 46.6 | 9.4 | 36.7 | 1.2 | 0.0 | 1.06 |
| Anode | Outlet | 0.0 | 0.0 | 3.9 | 49.8 | 6.1 | 39.0 | 1.1 | 0.0 | 1.11 |

### LIST OF REFERENCE SIGNS

1: carbon capture system
2: pressure swing adsorption unit
3: product gas
4: tail gas
5: molten carbonate fuel cell
6: cathode
7: anode
8: CO₂ separation means
9: water gas shift reactor
10: steam methane reformer
11: electric energy
12: de-sulfurization unit
13: natural gas
14: CO₂ depleted cathode outlet stream
15: captured CO₂
16: cathode inlet stream
17: cooling means

1. A carbon capture system, comprising:
a pressure swing adsorption unit configured to produce a product gas and a tail gas comprising at least one carbonaceous gas; and
a molten carbonate fuel cell having a cathode and an anode; wherein the molten carbonate fuel cell is configured to transfer CO₂ from the cathode to the anode, wherein the molten carbonate fuel cell is a multi-stage fuel cell,
wherein the anode is in fluid communication with the pressure swing adsorption unit for receiving at least a portion of the tail gas as an inlet stream.

2. The system according to claim 1, wherein the molten carbonate fuel cell is configured to run in electricity production mode and/or configured to not run in electrolysis mode.

3. The system according to claim 1, wherein the molten carbonate fuel cell is electrically connected to an electricity consumption means and/or an electricity storage means.

4. The system according to claim 1, wherein the molten carbonate fuel cell is a two-stage fuel cell.

5. The system according to claim 4, wherein the molten carbonate fuel cell is a two-stage fuel cell having a first cell and a second cell which are in fluid connection, wherein the fluid connection comprises one or more cooling means and/or one or more mixing means.

6. The system according to claim 1, further comprising a CO₂ separation means in fluid communication with the anode of the molten carbonate fuel cell; wherein the CO₂ separation means is configured to receive an outlet stream from the anode, wherein the CO₂ separation means is configure d to separate CO₂ from the outlet stream.

7. The system according to claim 6, wherein the pressure swing adsorption unit is in fluid connection with the CO₂ separation means; wherein the pressure swing adsorption unit is configured to receive an outlet stream from the CO₂ separation means as an inlet stream.

8. The system according to claim 6, wherein the CO₂ separation means is a low temperature phase change separation unit.

9. The system according to claim 6, further comprising a water-gas-shift reactor between the anode of the molten carbonate fuel cell and the CO₂ separation means.

10. The system according to claim 6, wherein the CO₂ separation means allows for a separation of CO₂ having a purity of 95 mol % or more.

11. The system according to claim 1, wherein the pressure swing adsorption unit is in fluid connection with a steam methane reformer; wherein the pressure swing adsorption unit is configured to receive an outlet stream from the steam methane reformer as an inlet stream.

12. A method of capturing carbon comprising:
producing a product gas and a tail gas by pressure swing adsorption, wherein the tail gas comprises at least one carbonaceous gas; and
feeding at least a portion of the tail gas as an inlet stream to an anode of a molten carbonate fuel cell, wherein the molten carbonate fuel cell is a multi-stage fuel cell,
wherein the molten carbonate fuel cell is configured to produce electric energy and configured to transfer CO₂ from a cathode to the anode.

13. (canceled)

14. (canceled)

15. CO₂ captured with a system according to claim 1.
